(19) United States
(12) Patent Application Publication
(10) Pub. No.: US 2005/0173165 A1
(43) Pub. Date: Aug. 11, 2005

(54) Lithotriptor carriage

(75) Inventor: Anton Haas, Muenchen (DE)

Correspondence Address: KING & SPALDING LLP, 191 PEACHTREE STREET, N.E., 45TH FLOOR, ATLANTA, GA, 30303-1763, US

(73) Assignee: Dornier MedTech Systems GmbH, Wessling (DE)

(21) Appl. No.: 10/367,651

(22) Filed: Feb. 14, 2003

(30) Foreign Application Priority Data
Feb. 7, 2003 (DE) 103 05 122.8

(51) Int. Cl. B60K 1/00

(52) U.S. Cl. 180/65.1

(57) ABSTRACT

The invention relates to a lithotriptor carriage comprising a moving device. For rendering the lithotriptors accessible to a possibly large field of application, a lithotriptor carriage comprising a moving device and an accommodating bed connected therewith, on which a lithotriptor can be mounted and detachably arrested on the carriage by means of an arresting device, is provided, wherein the lithotriptor is ready to be used in the mounted state.

The present invention relates to a lithotriptor carriage comprising a moving device.

In practice, mobile lithotriptors are known from therapy rooms. The lithotriptors are thereby typically moved between a treatment location and a storage area. For overcoming large distances the lithotriptors are, however, bulky and unsuitable, so that the possibilities to employ the same are limited.

The present invention is based on the object to provide a field of application for the lithotriptor that is as large and variable as possible.

According to the invention the object is provided by means of a lithotriptor carriage comprising the features of claim 1.

The lithotriptor is placed upon the carriage and simultaneously positioned in the accommodating bed. For securing the lithotriptor for a transport in this position, the lithotriptor can be detachably arrested on the carriage by means of an arresting device. With the lithotriptor being placed upon the carriage, it can—with the aid of the carriage—be moved over large distances and is, thus, accessible to a large and variable field of application. The lithotriptor can also be used when it is placed upon the carriage.

According to a particularly preferred embodiment of the invention, the accommodating bed is provided in a low portion of the carriage so as to keep the center of gravity of the unit formed of the lithotriptor and the carriage low.

According to a particular advantage, a bottom portion of the accommodating bed may be provided between the wheels of a wheel pair of the carriage in a sunken manner.

Thus, the working height of the lithotriptor in a mounted state is in the proximity of the area of the working height of the lithotriptor in a state spaced away from the carriage.

According to a favorable embodiment of the invention the bottom portion of the accommodating bed may be arranged underneath the wheel axes of a wheel pair of the carriage. Thus, the height of the wheel axes of the lithotriptor mounted on the carriage is smaller against a ground on which the carriage is located, in comparison with the case where the lithotriptor itself would be provided with wheels having the size of the wheel pair as is provided on the carriage.

According to an advanced development of the invention the carriage can comprise at least one wheel having a wheel diameter in the range of 150 mm and 400 mm, preferably having a wheel diameter of 230 mm. Wheels with such diameters allow a good movement on grounds particularly found outside hospital buildings.

The accommodating bed can at least section-wise comprise an accommodating profile designed in correspondence with the outer contour of the lithotriptor, onto which the lithotriptor can be placed at least portion-wise in a form-fit manner. Due to the form-fit form of the accommodating profile, a position adopted by the lithotriptor when being placed on the carriage can at least partially be predefined. Moreover, the lithotriptor is at least partially secured against a movement on the carriage in a mounted state as result of the form-fit form of the accommodating profile.

The accommodating bed can preferably comprise at least one wheel recess, in which at least one wheel of the lithotriptor can be positioned. By positioning one wheel of the lithotriptor in the wheel recess, it is secured that the lithotriptor adopts at least partially a desired accommodating position on the carriage. Moreover, according to the form of the wheel recess, the lithotriptor is at least partially secured against a movement on the carriage when being placed on the same.

In the portion of a wheel recess of the carriage a holding jaw may favorably be provided, with which a lithotroptor wheel positioned in the wheel recess can be secured in this position. The holding jaw reliably anchors the lithotriptor wheel in the wheel recess.

According to a particularly preferred embodiment of the invention the carriage may be provided with at least one lifting handle permitting an operator to transmit a lifting power to the carriage so as to overcome obstacles more easily.

According to a favorable advanced development of the invention the carriage may comprise at least one brake, by means of which at least one wheel can be braked. A brakable wheel secures the carriage at least partially against a movement on a ground on which the carriage is located.

According to another preferred embodiment of the invention the brake is a hydraulic brake. A hydraulic brake is particularly effective and can be realized in a small construction size.

A brake gear may preferably be connected, in a spaced manner, to a brakable wheel of the carriage and with the same by means of an endless drive. This permits the provision of the brake gear at a location of the lithotriptor which is favorable for affixing the brake gear. This location may, moreover, be selected such that the outer dimensions of the carriage are substantially maintained by the provision of the brake gear.

The brake may favorably comprise an operating element attachable on the lithotriptor. By means of the same the brake can be remotely controlled from a position on the lithotriptor.

According to a particularly preferred embodiment of the invention the moving device may comprise at least one, preferably electrically driven, driving unit for driving at least one wheel of the moving device. With a driven carriage it is easy for an operator to move the same.

According to a particularly favorable embodiment of the invention the carriage may comprise at least one additional container being detachably affixable on the carriage. Articles required for the carriage and/or the lithotriptor can be transported with the carriage in an additional container. During the transport the additional container is attached to the carriage. If access to the additional container is necessary, the same can be detached from the carriage.

Separate protection is claimed for a unit consisting of a lithotriptor and a lithotriptor carriage comprising the features of at least one of claims 1 to 15.

An embodiment of the invention is illustrated in the drawing and will be explained in the following, wherein

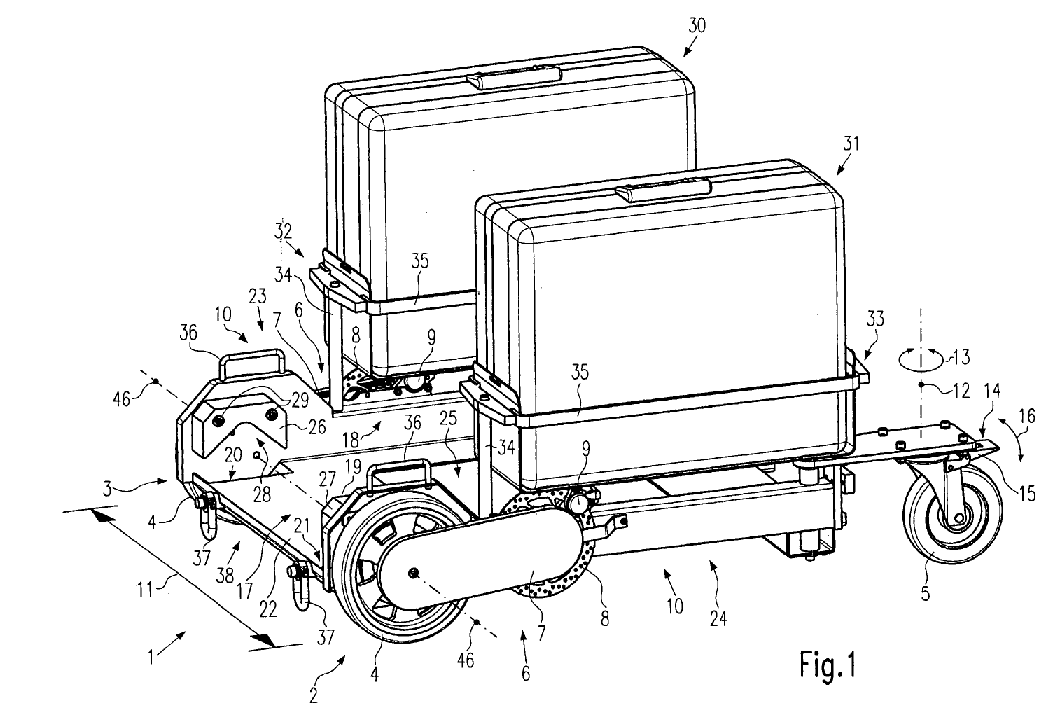

FIG. 1 shows a perspective view of a lithotriptor carriage according to the invention, and

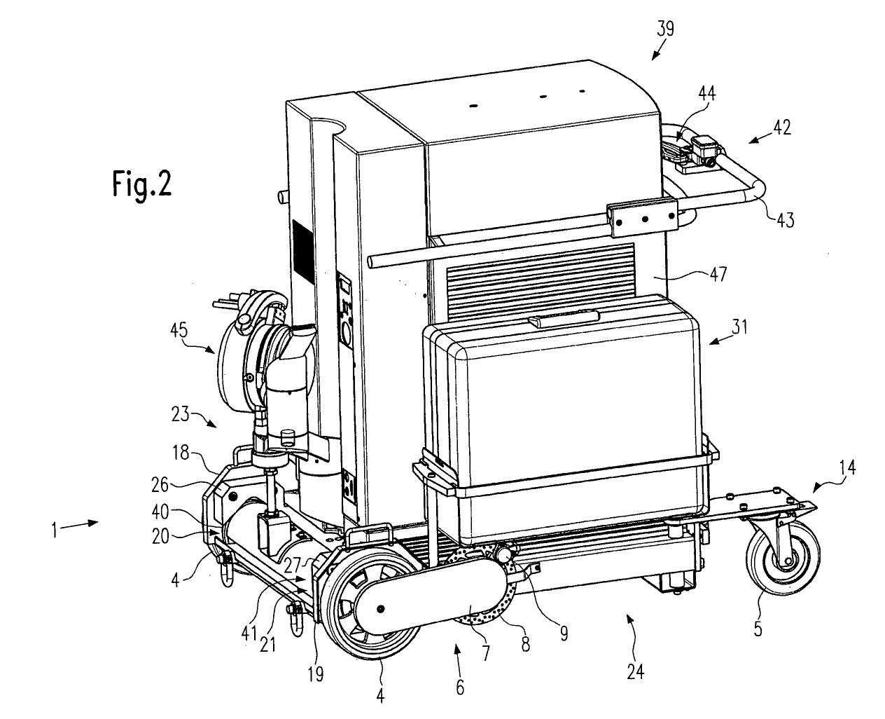

FIG. 2 shows a perspective view of a lithotriptor carriage according to FIG. 1 with a mounted lithotriptor.

In the following description the same reference numbers will be used for the same parts. For avoiding repetitions, reference is made to respective preceding or still following explanations.

FIG. 1 shows a lithotriptor carriage 1 according to the invention in a perspective view. The carriage comprises a moving device 2 and an accommodating bed connected thereto.

The moving device is provided with a first wheel pair with first wheels 4 and a second wheel pair with second wheels 5. In the illustration of FIG. 1 one wheel 5 of the second wheels 5 is hidden. The wheels 4, 5 have wheel diameters ranging from 150 to 400 mm. The first wheels 4 thereby have a wheel diameter of 230 mm. The wheel diameter of the second wheels 5 is smaller than the wheel diameter of the first wheels 4.

The moving means 2 comprises two brake gears 6, whereby each of said brake gears is forcibly connected with one of the first wheels 4 by means of an endless drive. According to this embodiment of the invention the endless drive is a chain running underneath a cover 7. Toothed wheels (not shown) are provided on brake discs 8 of the brake gears 6 and on the first wheels 4, over which the chains (not shown) are moved. Thus, rotational movements of the first wheels 4 are transmitted to the brake discs 8. Braking forces transmitted to the brake discs 8 by means of hydraulic calipers 9 are each transmitted to the first wheels 4.

According to another embodiment of the invention the endless drive can also be realized by means of belts, especially toothed belts, or toothed wheels.

The brake gears 6 are each provided on longitudinal outer sides 10 of the moving device 2 of the carriage 1. By the attachment position of the brake gears 6 spaced away from the first wheels 4 a width 11 of the carriage 1 is only slightly increased by the provision of the brake gears 6.

A foot parking brake 14 is provided on the two wheels 5, each of which can be pivoted for steering purposes about a steering axis 12 in the direction of the arrow 13. By actuating an operating element 15 in the direction of the arrow 16 through an operator the foot parking brake 14 is either released or pulled.

According to another embodiment of the invention an electrically driven drive unit is provided, by means of which the first wheels 4 can be driven. The drive unit thereby comprises a separate electric motor for each of the first wheels 4.

The accommodating bed 3 is provided in a low portion of the moving device 2 of the carriage 1. A bottom portion 17 of the accommodating bed 3 is thereby provided between the first wheels 4 in a sunken manner, namely underneath wheel axes 46 of the first wheels 4. The accommodating bed 3 is section-wise designed in correspondence with an outer contour of a lithotriptor to be mounted. The accommodating bed thereby comprises an accommodating profile with first and second side walls 18, 19 and first and second wheel recesses 20, 21. The side walls 18, 19 are each approximately vertically aligned to a bottom plane 22 of the bottom portion 17 and are positioned opposite each other and adjacent to the bottom portion 17. The first side wall 18 supports a mounted lithotriptor towards a first side 23 of the carriage 1, the second wall 19 towards a second side 24 of the carriage 1.

The first and second wheel recesses are deepened against the bottom plane 23 of the bottom portion 17. The shape of the wheel recesses 20, 21 corresponds to the shape of the wheels of the lithotriptor to be received therein. In accordance therewith, the wheels of the lithotriptor are receivable in the wheel recesses 20, 21 in a form-fit manner. By receiving wheels of the lithotriptor in the wheel recesses 20, 21 in a form-fit manner the lithotriptor is secured against a movement in the longitudinal direction against the carriage 1. In addition, the wheel recesses 20, 21 according to this embodiment also secure the lithotriptor against a movement transversely against the carriage 1 in the portion of the wheel recesses 20, 21.

According to this embodiment also the side walls 18, 19 are section-wise formed such that they correspond to the outer shape of the lithotriptor to be accommodated, especially of a body of the lithotriptor. Thus, the lithotriptor can be accommodated in a form-fit manner also in the portion of the side walls 18, 19. In the accommodated state the lithotriptor, and especially its body, is secured against a movement transversely to the longitudinal direction of the carriage 1.

According to another embodiment of the invention the carriage may also be constructed without having side walls.

The bottom portion 17 is likewise section-wise designed so as to correspond to an outer contour of the lithotriptor to be accommodated. Accordingly, the lithotriptor to be accommodated can be accommodated in the bottom portion 17 section by section in a form-fit manner and can be supported section by section.

According to another embodiment of the invention a lithotriptor to be accommodated may also be accommodated by a bottom plane of a bottom portion spaced away from the accommodating bed.

A sparing 25 is provided in the bottom portion 17. In another embodiment of the invention the sparing may be used for receiving and/or arresting the lithotriptor to be accommodated.

Opposite the first and second wheel recesses 20, 21 first and second holding jaws 26, 27 are provided on the side walls 18, 19. The holding jaws 26, 27 permit to secure lithotriptor wheels positioned in the wheel recesses 20, 21 against a movement out of the wheel recesses 20, 21. The holding jaws 26, 27 each comprise a holding profile 28, by means of which the holding jaws 26, 27 are adapted to rest on the wheels of the lithotriptor. The holding jaws 26, 27 are releasably affixed to the side walls 18, 19 by means of screws 29.

According to another embodiment of the invention additional arresting devices may be provided, by means of which a lithotriptor mounted on the carriage 1 can be arrested on the carriage 1.

A first and a second additional container 30, 31 are provided on the carriage. The additional containers 30, 31 are trunk-shaped and detachably attached on the carriage 1 by first and second holding devices 32, 33. The holding devices 32, 33 are each provided with rod-like height retainers 34 and belt-like circumferential retainers 35 received on the same.

Lifting handles 36 are arranged at the side walls 18, 19 of the carriage 1. By means of the lifting handles 36 an operator can transmit a lifting power to the carriage 1. This may be helpful for overcoming larger obstacles, e.g. curbstone edges.

The lifting handles 36 are moreover usable for securing a therapy device of the lithotriptor. For this purpose a belt is positioned on the therapy device and is fixed on at least one of the lifting handles.

Eyelets 37 are provided at a front end 38 of the carriage 1. By means of the eyelets 37 the carriage 1 can be secured with securing means in a predefined position, for instance, against a vehicle, if the carriage is transported in the vehicle.

FIG. 2 shows the carriage 1 with the lithotriptor 39 mounted thereon, whereby a base of the lithotriptor 39 rests on the bottom plane 22 of the carriage 1. First and second lithotriptor wheels 40, 41 are each positioned in a wheel recess 20, 21. The holding jaws 26, 27 are each adjacent to the lithotriptor wheels 40, 41 so that the lithotriptor wheels 40, 41 are secured in their position. The lithotriptor wheels 40, 41 and lateral portions of the lithotriptor 39, especially the body 47 thereof, are each adjacent to the side walls 18, 19 of the carriage 1. The lithotriptor 39 is moreover supported by the bottom portion 17.

The lithotriptor 39 comprises a rail 43 in an upper portion 42. The rail 43 constitutes a handle with the aid of which forces exerted by an operator can be transmitted to the lithotriptor 39.

A lever-handle-like operating element 44 is provided on the rail 43. By actuating the operating element 44 through an operator, the brake gears 6 of the carriage 1 can be operated, whereby especially the hydraulic calipers 9 are actuated so as to transmit a braking force onto the brake discs 8.

The lithotriptor 39 can be employed in the position mounted on the carriage 1, whereby the range in which the therapy device 45 of the lithotriptor 39 can be adjusted is raised from a ground, on which the carriage 1 stands, only to such an extent that corresponds to the distance of a deepest point of the respective wheel recesses 20, 21 from the ground.

The mode of operation of the lithotriptor carriage 1 will be described in the following.

At first, the lithotriptor 39 is placed upon the carriage 1. This may be effected by moving the same with a ramp or by lifting it up. The lithotriptor 39 is thereby positioned on the carriage 1 such that its wheels 40, 41 are each positioned in one of the wheel recesses 20, 21. Afterwards the holding jaws 26, 27 are each mounted above the lithotriptor wheels 40, 41 by means of screws 29. This secures the position of the lithotriptor wheels 40, 41 in the wheel recesses 20, 21 and, simultaneously, the position of the lithotriptor on the carriage 1 as a whole. The lithotriptor is thereby accommodated by the accommodating bed 3 section-wise in form-fit manner.

For moving the lithotriptor 39 by means of the carriage 1 the foot parking brakes 14 and the brake gears 6 are brought into a released state by an operator. By means of the rail 43 the operator produces the forces required for moving the unit consisting of the lithotriptor and the carriage.

Once arrived at the destination, the foot parking brakes 14 and brake gears 6 are brought into an arrested state by the operator. The operator may, in the appropriate circumstances, remove needed articles from the additional containers 30, 31 and start to employ the lithotriptor 39, especially the therapy device 45.

1-16. (canceled)

17. A carriage for transporting a lithotriptor and supporting the lithotriptor during normal operation, comprising:
an accommodating bed operative to support a lithotriptor;
a moving device coupled to the accommodating bed operative to facilitate transportation of the lithotriptor; and
an arresting device coupled to the accommodating bed operative to detachably arrest the lithotriptor.

18. The carriage according to claim 17, wherein the carriage comprises a lower portion, and wherein the accommodating bed is provided in the lower portion.

19. The carriage according to claim 18, wherein the moving device comprises a pair of wheels, and wherein the accommodating bed is sunken between the wheels.

20. The carriage according to claim 18, wherein the moving device comprises two wheels attached to the accommodating bed, and wherein a bottom portion of the accommodating bed is underneath the axes of the wheels.

21. The carriage according to claim 19, wherein the moving device comprises at least one wheel having a diameter between 150 mm and 400 mm.

22. The carriage according to claim 19, wherein the accommodating bed comprises a profile that corresponds at least section-wise with an outer contour of the lithotriptor, and wherein the profile accommodates placement of the lithotriptor.

23. The carriage according to at claim 19, wherein the accommodating bed comprises at least one recess in which at least one wheel of the lithotriptor can be positioned.

24. The carriage according to claim 19, wherein the accommodating bed comprises at least one recess, and wherein the arresting device comprises at least one holding jaw operative to secure at least one wheel of the lithotriptor positioned in the recess.

25. The carriage according to claim 24, further comprising at least one lifting handle.

26. The carriage according to claim 19, further comprising at least one brake operative to brake at least one wheel of the pair of wheels.

27. The carriage according to claim 26, wherein the at least one brake comprises a hydraulic brake.

28. The carriage according to claim 26, wherein the at least one brake comprises a gear coupled to the at least one wheel by an endless drive.

29. The carriage according to claim 26, further comprising an operating element coupled to the brake, wherein the operating element is operative to transmit braking force applied by an operator to the at least one wheel.

30. The carriage according to claim 18, wherein the moving device comprises at least one wheel coupled to at least one electric drive unit.

31. The carriage according to claim 19, further comprising at least one container coupled to the carriage.

32. The carriage according to any of claims 17-21, further comprising a lithotriptor mounted thereto.
